(19) United States
(12) Patent Application Publication
(10) Pub. No.: US 2020/0180354 A1
(43) Pub. Date: Jun. 11, 2020

(54) PAINT TUBE BIB

(71) Applicant: Harvey Reese, Philadelphia, PA (US)

(72) Inventor: Harvey Reese, Philadelphia, PA (US)

(21) Appl. No.: 16/214,003

(22) Filed: Dec. 7, 2018

(51) Int. Cl. B44D 3/12; B44D 3/02

(52) U.S. Cl. CPC B44D 3/128; B44D 3/02

(57) ABSTRACT

A paint tube bib has an upper surface that is a pallette, and an opening therethrough. The underside of the paint tube bib has three prongs that allow the paint tube bib to be disposed atop the neck of a paint tube such that the prong secure the paint tube bib therein. The upper surface serves as a pallette which also protects the neck from paint, and thereby allows a cap to be replaced on the neck when the pallette is removed, so that the neck can be secured in air tight engagement on the neck, thereby protecting the contents of the paint tube. The paint tube bib is preferably very thin, like the acetate of a bubble pack. A first raised ridge surrounds the outer periphery of the upper surface, and a second raised ridge surrounds the opening.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF THE INVENTION

The present invention relates to devices to which are useful to protect the neck of a tube from the contents of the tube, as for example to protect the neck of a paint tube from paint spatter and droppings, so that a cap will be effective to seal the paint tube when it is replaced on the paint tube.

### BACKGROUND OF THE INVENTION

Unless an artist is diligently clean when he paints from a tube, the excess dries and cakes on the threaded neck of the tube, making it difficult to screw the cap back on and achieve the necessary airtight closure. The result is that air eventually hardens the contents inside the tube, making the tube useless. Tubes of paint are expensive, so there is a demand for a simple and inexpensive way to preserve them. Unless an artist is diligently clean, when he paints from a tube the excess paint dries and cakes on the threads, making it difficult or impossible to screw the cap back on in a way to provide the necessary air tight closure. Over time the paint in the tube dries up, making it unusable. Tubes of paint are expensive, so something simple and inexpensive to preserve them would be appreciated by every artist.

Accordingly, it is a problem in the art to provide a device which keeps the threaded neck of a tube container clear of excess material and protected from outside air, thus preventing blockage.

Additionally, it is a problem in the art to provide a simple and easy to use palette, which is inexpensive and disposable after use.

### SUMMARY OF THE INVENTION

From the foregoing, it is seen that it is a problem in the art to provide a device meeting the above requirements. According to the present invention, a device is provided which meets the aforementioned requirements and needs in the prior art

Specifically, the device according to the present invention is useful to protect the neck of a paint tube from the contents of the tube, as for example to protect the neck of a paint tube from paint spatter and droppings, so that a paint tube cap will be effective to seal the paint tube when it is replaced on the paint tube.

Further, the paint bib of the present invention functions as a miniature palette, enabling the artist to work close to the canvas instead of returning time and again to the palette table to refresh their brush.

The device is not limited to paint tubes, and can be used in other areas. For example, the device of the present invention will be useful with other instances where a bib like this might be usefull to prevent drips and splatters—specifically nail polish bottles and baby food jars. Other uses, such as for varnish, adhesives in liquid form, sealant, among others which would be apparent to one skilled in the relevant arts, are completed as being within the scope of the present invention.

The invention includes a pronged bottle cap which displaces excess contents from the interior neck of a tube container, maintaining the usefulness of both the contained material as well as said tube

Alternatively, a 3-sided prong may be used to fit fractionally different bottle neck sizes as shown and described

Alternatively, a paint tube palette having an opening at its center to dispense contents may be included as part of said pronged cap as shown and described, allowing one to mix or hold paint

Other objects and advantages of the present invention will be more readily apparent from the following detailed description when read in conjunction with the accompanying drawings

### BRIEF DESCRIPTION OF THE DRAWINGS

FIG. 1. Is a side view of a ordinary bottle cap above a paint tube with a neck obstructed by hardened excess contents.

FIG. 2. Is a side view of a another embodiment of a threaded bottle cap with an attached prong according to the invention, a portion of the prong being visible in dashed outline below the top of the bottle cap.

FIG. 3. Is a side view of a paint tube and a paint bib, the paint bib having a paint tube palette and three prongs for insertion into the paint tube.

FIG. 4. Is a top view of the paint bib of FIG. 1 disposed above the neck of a paint tube, showing a pallette having an opening, which allows material to be squeezed out from the paint tube.

FIG. 5. Is a bottom elevational view of the paint bib of FIG. 4, showing the end view of the three prongs and an underside of the paint bib.

FIG. 6. Is a perspective view of the paint bib secured on the paint tube, showing contents applied to or squeezed onto the miniature palette portion, and showing a paintbrush being used in conjunction with the paint bib.

FIG. 7. Is a perspective view of a paint tube with threaded neck which is clear of paint buildup after the use of a paint tube bib and removal of the paint tube bib from the threaded neck.

### DETAILED DESCRIPTION OF THE INVENTION

Unless an artist is diligently clean, when he/she paints from a tube the excess paint dries and cakes on the threads, making it difficult or impossible to screw the cap back on in a way to provide the necessary air tight closure. Over time the paint in the tube dries up, making it unusable. Tubes of paint are expensive, so something simple and inexpensive to preserve them would be appreciated by every artist. This invention is directed to this goal, namely a paint bib 100 shown in FIGS. 3, 4, 5, and 6.

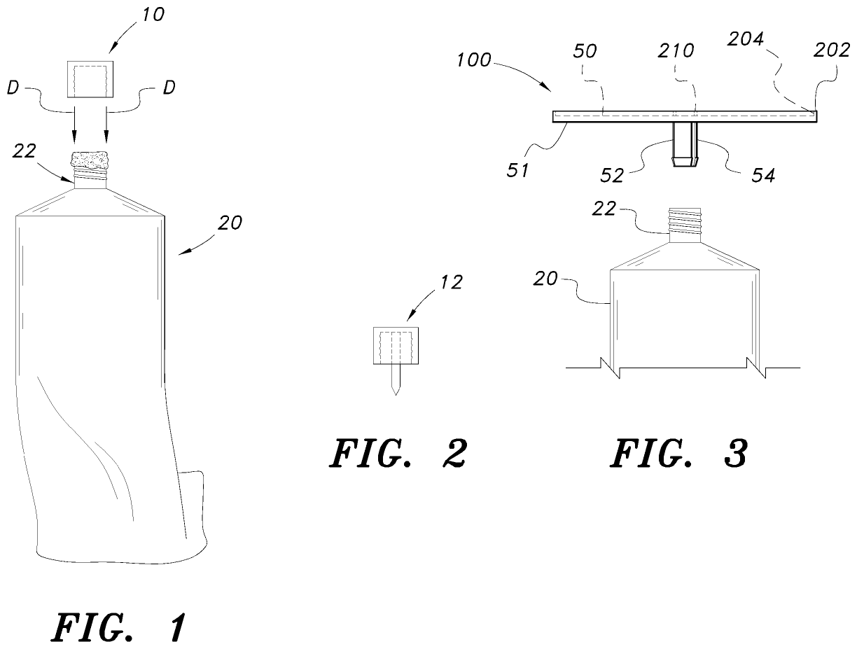

More specifically, the paint bib 100 is intended for use with a tube neck 22 of a paint tube 20 as shown in FIGS. 1, 3, and 6. The paint bib 100 of FIGS. 3, 4, 5, and 6 shows a very thin pallette 50, perhaps one sixteenths of an inch thick or even thinner, and three prongs 52, 54, and 56 that extend only a little way into the neck, for example just one eighth inch into the neck, or in another example the prongs are longer and extend one eighth inch past the tube neck 20 into the paint tube 20. The material forming the paint bib 100 is preferably like the acetate on a bubble pack, in thickness and stiffness. The paint bib 100 can be composed of any material that is relatively stiff so as to support paint on a pallette, and sufficiently thin as to be relatively low in cost and so as to be considered disposable.

Further, the paint bib 100 functions as an in-hand mini-palette, enabling the artist to work close to the canvas instead of repeatedly tuning back to the palette table to refill his brush. Further features and advantages are described in the following.

FIG. 1. Is a side view of a ordinary paint tube cap 10 moved in a direction D toward a tube neck 22 of a paint tube 20. The paint tube 20 has a neck 22 obstructed by hardened excess contents, indicated by the legend “dried paint” in FIG. 1.

While a paint tube 20 is shown, the same condition can occur with other types of containers in paint cans, jars, bottles, and tubes, including baby food bottles, nail polish bottles, and so on. The invention can be used where any type of bottle, jar, or tube needs to have protection from contents spilling onto the neck thereby preventing air tight closure of a cap or lid. In these instances, the paint bib 100 can be modified to have differing proportions if needed such as between the opening 60 relative to the overall outer diameter of the paint bib 100, as one example, The present invention is contemplated as including all such additional uses.

FIG. 2. Is a side view of another embodiment of a paint tube cap, showing a threaded bottle cap 12 with an attached prong wherein a dashed outline shows how the prong extends to the upper end of the cap 12. In this case, the prong clears the interior neck of the container, such as the paint tube 20 of FIG. 1, of any obstruction as it descends, and keeps the interior open when the cap is removed again.

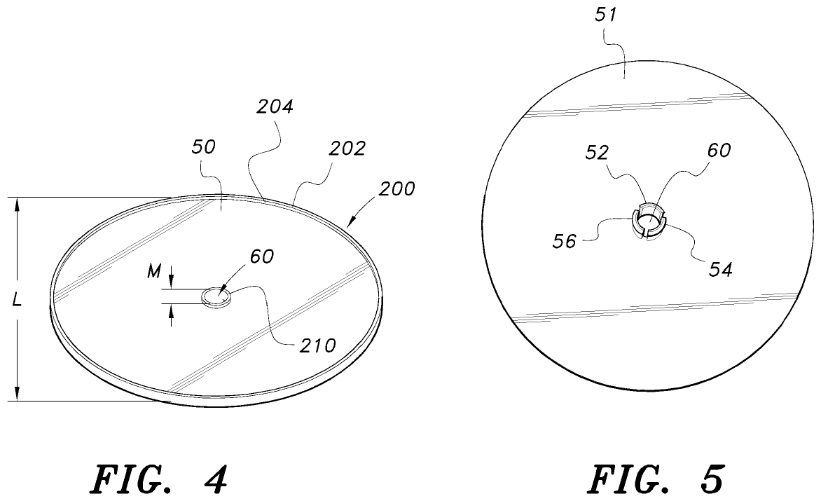

FIG. 3. Is a side view of a paint bib 100 (also referred to herein as a paint tube bib 100) disposed over an uppermost portion of a paint tube 20 with a paint tube neck 22. The paint tube bib 100 has an upper surface 50 (shown in dashed outline in FIG. 3), also referred to herein as a pallette 50, which is adapted to be used as a paint palette and which is used to hold paint. The paint tube bib 100 has a lower surface 51 and has three downwardly-projecting prongs 52, 54, and 56 (shown in FIG. 5) equi-angularly arranged about an opening 60 (shown in FIGS. 4 and 5). The downwardly projecting prongs 52, 54, and 56 serve to fit into the interior of the neck 22 and hold the paint tube bib 100 securely atop the paint tube 20.

The paint tube bib 100 has an upstanding ridge 200 along the outermost periphery of the upper surface 50 (shown in FIGS. 4 and 5) and also has an upstanding ridge 210 bounding the opening 60 (shown in dashed outline in FIG. 3 and also shown in FIG. 4). The upstanding ridge 200 has an uppermost edge 202, and also has an innermost surface 204, the innermost surface 204 being shown in dashed outline in FIG. 3 and also being shown in FIG. 4. The upstandiing ridge 200 is also shown in FIG. 6, and the upstanding ridge 210 is also shown in FIG. 6. The upstanding ridges 200 and 210 are preferably ⅜ inches in height above the surface 50, but are contemplated as being of any height preferably in a range from 0.0001 inches to 0.5 inches. The drawings shown are illustrative and are not intended as being necessarily shown to scale.

The prongs are relatively thin and are flexible, such that they are adapted to fit into a variety of sized of neck opening for fitting fractionally different bottle neck sizes. The dimensions and thicknesses are as discussed hereinabove. The paint tube bib 100 can have an outer diameter or width in a range of 1 inch to 3 inches, for example.

A significant feature of the paint tube bib 100 is that it is preferably very thin, so that it is low in cost and can be considered disposable, as discussed above. It is similar in thickness to an acetate film of a bubble pack, for example.

FIG. 4. Is a top elevational view of the paint bib 100 having a diameter indicated by the letter L, and having an opening 60 therein with a diameter indicated by the letter M. The opening 60 allows material to be squeezed out from the paint tube 20, and/or allows material to be removed by a paint brush, for example.

FIG. 5. is a bottom elevational view of the paint bib 100 showing the lower surface 51, and shows an end view of the three prongs 52, 54, and 56 which are spaced evenly about the periphery of the opening 60. The dimensions and composition of the prongs are as discussed in the foregoing.

FIG. 6. Is a perspective view of the paint bib 100 in actual use atop the paint tube 20. The pallette 50 has paint blobs labelled in this view as Paint P and Paint S, and are exemplary. More or fewer paint blobs can be used, as desired by the artist. In actual use, the paint blobs can be used for painting, and to mix colors as desired by an artist. A paintbrush 300 is shown as it might appear when using the pallette 50 for painting.

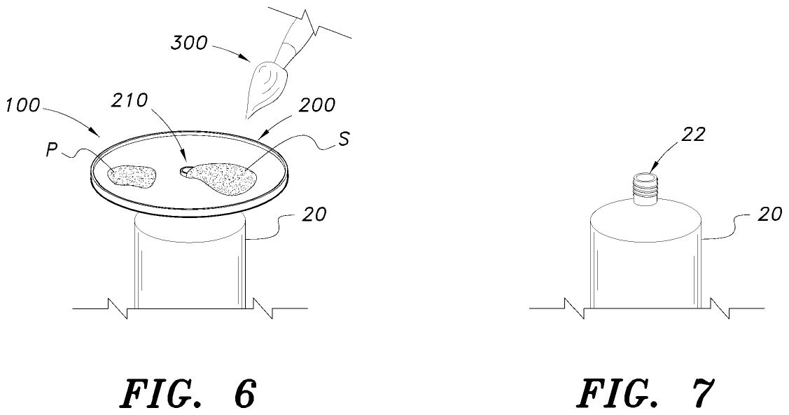

FIG. 7. Is a perspective view of a paint tube 20 with threaded neck 22 clear of paint buildup after the use of a paint bib 100. As seen, the paint bib 100 has kept the neck 22 completely clear of paint, and thus a cap can easily close the paint tube 20 in an air tight engagement.

The device is not limited to paint tubes, and can be used in other areas. For example, the device of the present invention will be useful with other instances where a bib like this might be usefull to prevent drips and splatters—specifically nail polish bottles and baby food jars. Other uses, such as for varnish, adhesives in liquid form, sealant, among others which would be apparent to one skilled in the relevant arts, are completed as being within the scope of the present invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A paint tube bib for protecting a neck of a paint tube during use so that the neck remains clear in order to allow resealing of a cap on the paint tube in air tight engagement after use, comprising:
a body which is thin and disk-shaped, said body having an opening therethrough; said body having an upper surface and a lower surface; said upper surface being adapted to serve as a paint pallette so as to support paint thereon;
a plurality of prongs on and extending from said lower surface of said body; said prongs being adapted to be inserted into the neck of the paint tube to support said body thereon while in use;
whereby during use said pallette protects the neck from spatter, so that after use when said body is removed the neck is clean and free of spatter, such that the cap of the paint tube can be replaced in air tight engagement so as to protect the contents of the paint tube.

2. The paint tube bib as claimed in claim 1, wherein said body is generally disk-shaped and round, and has a thickness of generally one-sixteenth inch.

3. The paint tube bib as claimed in claim 1, wherein said plurality of prongs comprises three prongs.

4. The paint tube bib as claimed in claim 3, wherein said three prongs are equi-angularly spaced about said opening.

5. The paint tube bib as claimed in claim 4, wherein said three prongs extend approximately one-eighth inch into the neck.

6. The paint tube bib as claimed in claim 4, wherein said three prongs extend approximately one-eighth inch beyond the neck into the paint tube.

7. The paint tube bib as claimed in claim 1, further comprising a raised ridge disposed on said upper surface of said body, adapted to prevent spilling of paint from said upper surface of said body.

8. The paint tube bib as claimed in claim 7, wherein said raised ridge disposed on said upper surface of said body extends along an outer periphery of said upper surface of said body.

9. The paint tube bib as claimed in claim 1, further comprising a raised ridge disposed on said upper surface of said body, said raised ridge surrounding said opening in said body.

10. The paint tube bib as claimed in claim 1, further comprising a first raised ridge disposed on said upper surface of said body, adapted to prevent spilling of paint from said upper surface of said body, wherein said first raised ridge is disposed on said upper surface of said body and extends along an outer periphery of said upper surface of said body completely bounding said upper surface of said body; and further comprising a second raised ridge disposed on said upper surface of said body, said second raised ridge being disposed adjacent to said opening in said body and completely bounding said opening in said body.

11. A bib for protecting a neck of a container having fluid contents during use so that the neck remains clear in order to allow resealing of a cap on the container in air tight engagement after use, comprising:
a body which is thin and disk-shaped, said body having an opening therethrough; said body having an upper surface and a lower surface; said upper surface being adapted to serve as a paint pallette so as to support paint thereon;
a plurality of prongs disposed on said lower surface of said body, said plurality of prongs extending from said lower surface of said body; said prongs being adapted to be inserted into the neck of the container to support said body thereon while in use;
whereby during use said upper surface serving as a pallette protects the neck from spatter, so that after use when said body is removed the neck is clean and free of spatter, such that the cap of the container can be replaced in air tight engagement so as to protect the contents of the container.
